(19) United States
(12) Patent Application Publication
(10) Pub. No.: US 2004/0037636 A1
(43) Pub. Date: Feb. 26, 2004

(54) Locking mechanism for docking modular cafeteria units

(76) Inventors: Leonard Babcock, Dover, DE (US); Brian Powell, Dover, DE (US); Martin Stoken, Wyoming, DE (US)

Correspondence Address: Connolly Bove Lodge & Hutz LLP, P.O. Box 2207, Wilmington, DE, 19899-2207, US

(21) Appl. No.: 10/224,762

(22) Filed: Aug. 21, 2002

(51) Int. Cl. B25G 3/00

(52) U.S. Cl. 403/353

(57) ABSTRACT

The present invention is directed to a device for locking modular cafeteria units that can form a cafeteria line up. The device comprises two sub-assemblies: (A) a male bullet catch; and (B) a female receiver with a locking plate. The male bullet catch has a single annular groove cut to mate with the locking plate of the female receiver assembly. The spring-loaded receiver releasably mates with the male bullet catch to connect the cafeteria units.

### BACKGROUND OF THE INVENTION

The present invention is directed to a device that is a locking mechanism. The device is particularly suited for docking modular cafeteria units, such as food preparation stations and warming tray stations, to form a cafeteria line. In such cafeteria lines, it is desired to keep the individual units connected. However, many times it is necessary to disconnect the individual units for cleaning or other service. Therefore, there is a need for a device that provides a locking mechanism for releasably connecting the individual cafeteria units.

### SUMMARY OF THE INVENTION

The present invention is a locking device for locking modular cafeteria units that can form a cafeteria lineup. The device comprises two sub-assemblies: (A) a male bullet catch; and (B) a female receiver with a locking plate. The male bullet catch has a single annular groove cut to mate with the locking plate of the female receiver assembly. The spring-loaded receiver releasably mates with the male bullet catch to connect the cafeteria units.

The locking mechanism of the present invention can be incorporated into the corresponding countertops of cafeteria units to be docked together. However, it is within the scope of the invention that the locking mechanism can be mounted in other locations as one of ordinary skill in the art would understand to enable two cafeteria units to be docked together. Additionally, while the invention is preferred for use in docking cafeteria units, the locking mechanism can also be used to dock a variety of freestanding units, or to secure a freestanding unit to a wall.

In view of the above, it is an object of the present invention to releasably connect cafeteria units. It is another object of the present invention that the units can be connected to each other with the locking mechanism by pushing two units together, that is, without having to manually open and close the locking mechanism. It is also an object of the invention that the locking mechanism can be opened with a lever.

Further scope of applicability of the present invention will become apparent from the following detailed description. However, it should be understood that the detailed description of the preferred embodiments of the invention is provided for illustration only. Various changes and modifications within the spirit and scope of the invention will become apparent to an ordinarily-skilled artisan from this detailed description. Therefore, it is understood that both the above general description and the following detailed description are exemplary and explanatory and do not restrict the scope of the claimed invention.

### BRIEF DESCRIPTION OF THE DRAWINGS

The present invention will become more fully understood from the following detailed description and the accompanying drawing, which is only illustrative, and is not limiting of the present invention.

FIG. 1. Fragmental exploded top plan view of the left-hand and right-hand sides of serving units showing the locking mechanism of the invention.

FIG. 2. Fragmental top plan view showing bullet catch in locking position.

FIG. 3. Fragmental top plan view showing lock bar engaged with the undercuts of the bullet catch.

FIG. 4. Exploded cross-sectional view in elevation taken along 4-4 of FIG. 1.

FIG. 5. Cross-sectional view in elevation taken along 5-5 of FIG. 3.

FIG. 6. Side elevational view partially broken away in cross-section taken along line 6-6 of FIG. 4.

FIG. 7. Side elevational view partially broken away in cross-section taken along line 7-7 of FIG. 5.

FIG. 8. Exploded view of the left-hand and right-hand sides of serving units.

### DETAILED DESCRIPTION OF A PREFERRED EMBODIMENT

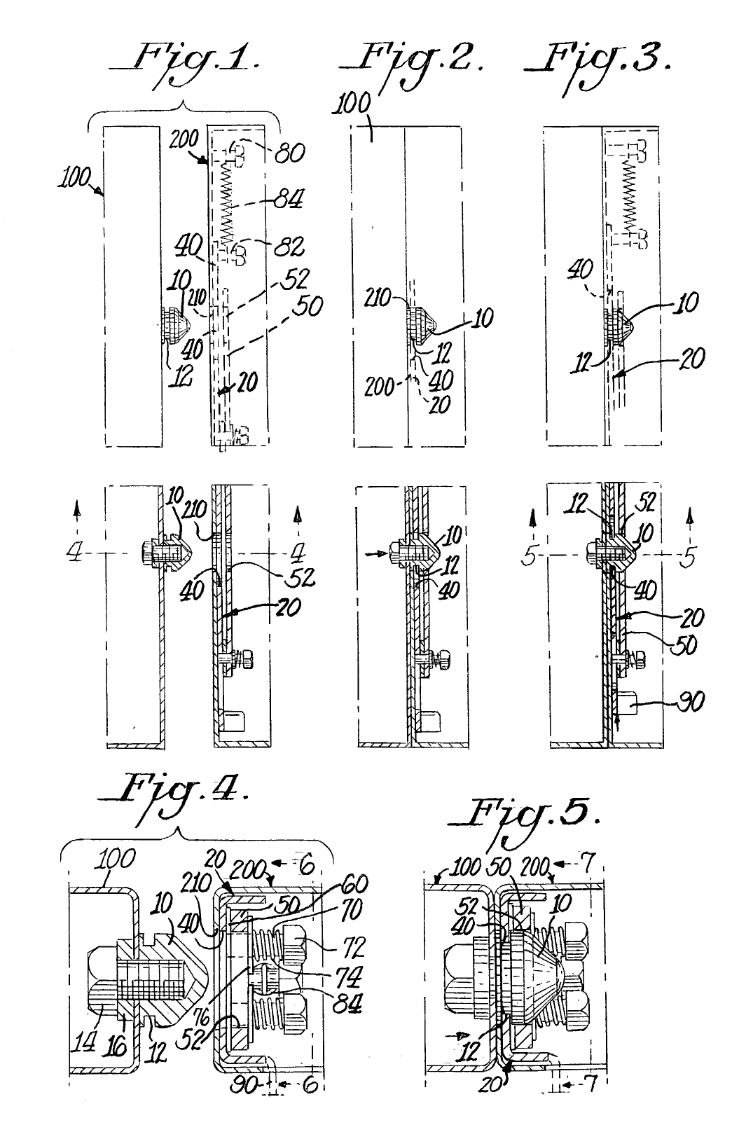

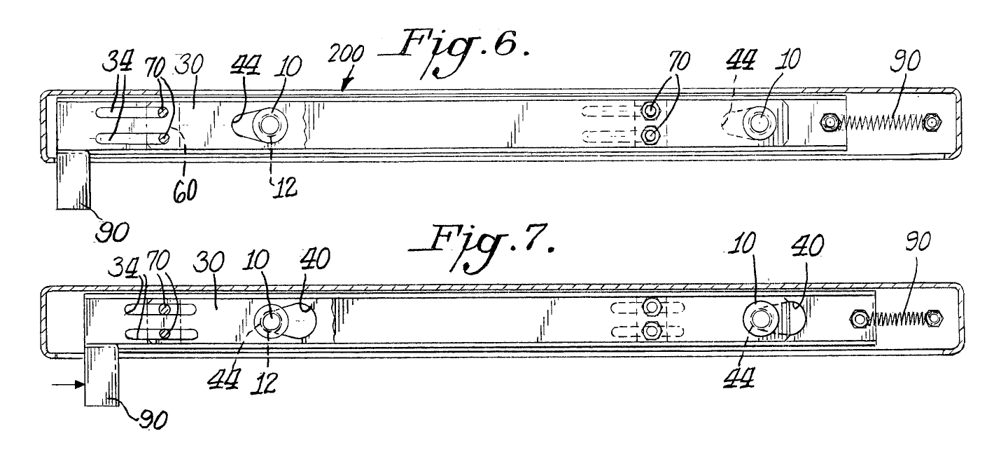

Referring to FIG. 1, that shows a preferred embodiment of the present invention, the bullet catch 10 having an undercut 12 is attached to the left-hand side 100 of a countertop of a cafeteria unit, the bullet catch 10 is secured to the left hand side 100 of the countertop by a bolt 14 that threaded into the bullet catch. Optionally, there is a washer 16 between the head of the bolt 14 and the left-hand side 100 of the top. The bullet catch 10 mates to the female receiver assembly 20 on the right-hand side 200 of a countertop of another cafeteria unit through a hole 210 in the right-hand side 200 of the countertop. The female receiver assembly 20 comprises a sliding lockbar 30 having a tapered elongated slot 40

and a tension bar 50. The tension bar 50 has a pin receiver hole 52 that corresponds to the bullet catch 10. A spacer 60 is located between the sliding lockbar 30 and the tension bar 50.

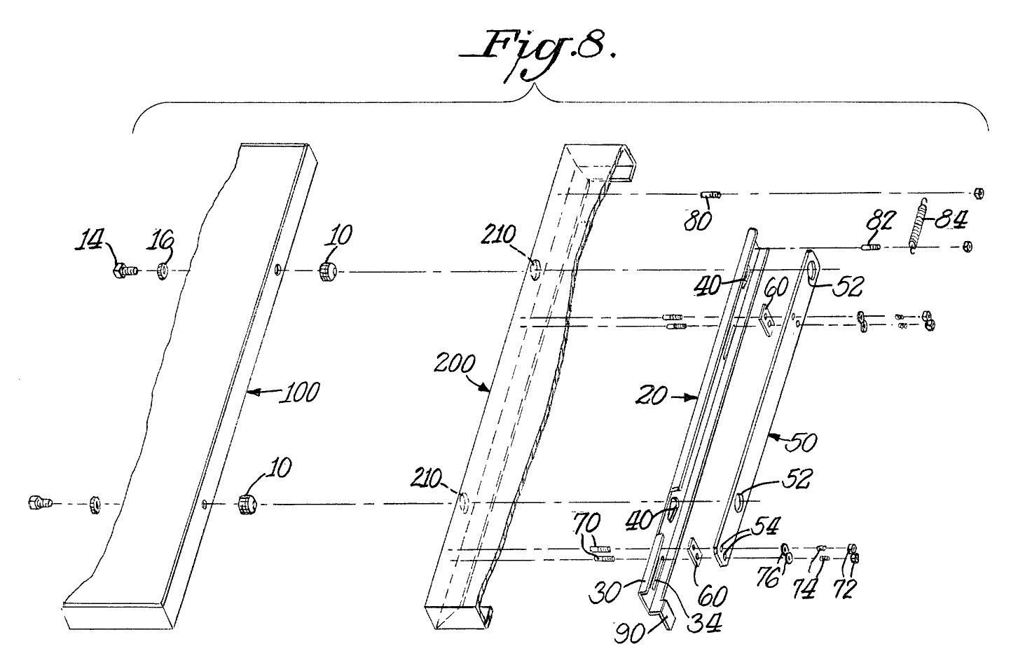

FIGS. 6 and 7 show that the sliding lockbar 30 has a taper elongated slot 32. The wide section 42 of the taper elongated slot corresponds to the outside diameter of the bullet catch 10. The small section 44 of the taper elongated slot corresponds to the diameter of the undercut 12 in the bullet catch 10.

Referring back to FIG. 1, attached to the right-hand side 200 of the top is a fixed pin 80 and attached to the sliding lockbar 30 is a lockbar pin 82. A tension spring 90 extends between the fixed pin 80 and the lockbar pin 82, the spring 84 is under tension to pull the sliding lockbar 30 towards the fixed pin 80.

When the bullet catch 10 is inserted into the female receiver assembly 20, as shown in FIG. 6, the conical portion of the bullet catch 10 entering the causes the sliding lockbar to move laterally from its initial position to allow the bullet catch 10 to be inserted into the female receiver assembly 20 by passing through the wide section 42 of the tapered elongated slot 40. When the bullet catch 10 is fully inserted into the female receiver assembly 20, the sliding lockbar 30 returns essentially to its initial position as shown in FIG. 7. The undercut 12 of the bullet catch 10 interfaces with the small section 44 of the tapered elongated slot 40 thus securing the bullet catch 10 in the female receiver assembly 20. FIGS. 5 and 7 show the bullet catch 10 secured in the female receiver assembly 20 by the sliding lockbar 30.

In FIG. 4, showing the same preferred embodiment as described above, the bolt 14 is shown threaded into the bullet catch 10. On the right-hand side 200 of the top, the sliding lockbar 30, spacer 60, and tension bar 50 are retained by threaded studs 70, that are fixed to the right-hand side 200 of the top, and tensioning nuts 72 that are threaded onto the studs 70. Each threaded stud 70 passes through a corresponding guide slot 34 in the sliding lockbar 30 and holes 54 in the tension bar. Additionally on each threaded stud 70, there is a spring 74 and a washer 76 between the tensioning nut 72 and tension bar 50. The spring 74 is compressed by the tensioning nut 72 which in turn stabilizes the tension bar 50 and sliding lockbar 30. The spacer 60 between the tension bar 50 and the sliding lockbar 30 is preferably comprised of a low friction material to allow the sliding lockbar 30 to slide when engaging the bullet catch 10.

Further shown in FIGS. 6 and 7 is a push arm 90 of the sliding lockbar 30 that is used to open the locking mechanism. To open the locking mechanism shown in the illustrated embodiment, the push arm 90 is moved towards the fixed pin 80 which allows the bullet catch 10 to be removed from the female receiver assembly 20 because the movement of the sliding lockbar 30 allows the bullet catch 10 to pass through wide section 42 of the tapered elongated slot. If necessary, the push arm 90 may be used to both open and close the female receiver assembly. However, the preferred method of operating the locking mechanism of the present invention is to have the female receiver assembly automatically secure, that is close, when the bullet catch is inserted, for example, by pushing the corresponding sides of two cafeteria units together. The mechanism is then opened using the push arm.

Additional embodiments of the invention include mounting the bullet catch to a building wall and having the cafeteria unit contain the female receiver. In this embodiment, the cafeteria unit can be releasably secured to the wall by pushing the cafeteria unit having the female receiver towards the wall having the bullet catch so as to engage the bullet catch into the female receiver.

While the invention has been particularly shown and described with reference to preferred embodiments thereof, it will be understood by those skilled in the art that various changes in form and details may be made without departing from the spirit and scope of the invention as defined in the appended claims.

What claimed is:

1. A locking mechanism comprising:
(A) a male bullet catch having an undercut; and
(B) a female receiver with locking pieces.

2. The locking mechanism of claim 1 having at least two male bullet catches.

3. The locking mechanism of claim 1, wherein the female receiver further comprises a sliding lockbar and a tension bar, further wherein the sliding lockbar has a tapered elongated slot that corresponds to the male bullet catch.

4. The locking mechanism of claim 3 wherein the female receiver further comprises a push arm that can be used to open and close the female receiver.

5. A locking mechanism for securing two cafeteria units comprising a male bullet catch having an undercut and a female receiver, wherein the locking mechanism automatically secures the cafeteria units when the units are pushed together.

6. A cafeteria line comprising at least a first cafeteria unit and a second cafeteria unit, said first cafeteria unit comprising a male bullet catch having an undercut, and said second cafeteria unit comprising a female receiver with locking pieces, wherein the female receiver further comprises a sliding lockbar and a tension bar, further wherein the sliding lockbar has a tapered elongated slot that corresponds to the male bullet catch.
